(19) United States
(12) Patent Application Publication
(10) Pub. No.: US 2010/0208497 A1
(43) Pub. Date: Aug. 19, 2010

(54) Light guide plates, display apparatuses using a light guide plate and methods of fabricating the same

(75) Inventors: Hoon Song, Yongin-si (KR); Yong-kweun Mun, Yongin-si (KR); Yoon-sun Choi, Incheon (KR); Hong-seok Lee, Seongnam-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 12/656,132

(22) Filed: Jan. 19, 2010

(30) Foreign Application Priority Data
Feb. 19, 2009 (KR) 10-2009-0014030

(51) Int. Cl. F21V 8/00; B05D 5/06; B29D 11/00

(52) U.S. Cl. 362/619; 427/162; 216/24

(57) ABSTRACT

Light guide plates having a filled-in type light emitting structure, display apparatuses using a light guide plate and methods of fabricating the same are provided, the light guide plates include a transparent light guide member, and a reflection member filled in the light guide member. The reflection member reflects light incident on the light guide member. The reflection member has a plurality of light exit holes through which light, reflected inside the light guide member, exits.

### CROSS-REFERENCE TO RELATED APPLICATIONS

This application claims the benefit of priority under 35 U.S.C. §119 from Korean Patent Application No. 10-2009-0014030, filed on Feb. 19, 2009, in the Korean Intellectual Property Office, the disclosure of which is incorporated herein in their entirety by reference.

### BACKGROUND

1. Field

Example embodiments relate to light guide plates having a filled-in type light emitting structure, display apparatuses using a light guide plate and methods of fabricating the same.

2. Description of the Related Art

Recently, as portable devices (e.g., personal digital assistants (PDAs), portable multimedia players (PMPs) and digital multimedia broadcasting (DMB) receivers) are increasingly used, there is a demand for display apparatuses exhibiting lower power consumption and/or increased outdoor visibility. For example, transmissive liquid crystal display (LCD) devices are widely used from mobile applications to television applications. The transmissive LCD device is embodied, for example, in a backlight unit (BLU). A general BLU includes a host of parts (e.g., a light source, a light guide plate and a prism sheet) so that there is a limit in making a product slim or flexible. In terms of performance, while exhibiting clear visibility in a dark environment, the transmissive LCD device has a limit in obtaining visibility in a bright environment.

To address the above problem, reflective LCD technology has been developed. The level of image quality of a reflective LCD device is lower than that of the transmissive LCD device. Because it is difficult to view the reflective LCD device in a dark environment, there are limits in the application of the reflective LCD technology.

To overcome the above problems, a transflective LCD device, in which a reflection portion and a transmissive portion are formed by dividing a pixel, has been developed. The process for forming the transflective LCD panel is complicated, which results in an increase in costs. Because the reflection portion uses a part of the pixel at an area rate of about 20%-80%, the reflection mode does not exhibit the same level of performance compared to a general reflective LCD device. Because the aperture ratio of the transflective LCD device is lower than that of the general transmissive LCD device in the transmissive mode, the light efficiency deteriorates compared to that of the general transmissive LCD device.

### SUMMARY

Example embodiments provide light guide plates having a filled-in type light emitting structure, display apparatuses using the same and methods of fabricating the same.

Additional aspects will be set forth in part in the description which follows and, in part, will be apparent from the description, or may be learned by practice of the example embodiments.

According to example embodiments, there is provided a light guide plate having a filled-in type light emitting structure, which includes a transparent light guide member, and a reflection member filled in the light guide member. The reflection member reflects light incident on the light guide member. The reflection member has a plurality of light exit holes through which light reflected inside the light guide member exits.

The reflection member may be formed of a metal (or a non-metal) having a substantially high reflectance, or by coating a metal (or a non-metal) having a substantially high reflectance on a material having a substantially low reflectance. The light guide member may include a light exit portion filling the light exit holes, and a light guide portion located on a side of the light guide member that is opposite to a light exit surface of the reflection member. The light guide portion may be integral with and/or optically coupled to the light exit portion. An index of refraction of the light exit portion may be equal to, or greater, than that of the light guide portion.

The reflection member may be a reflection film formed by coating a metal, or a non-metal, having a substantially high reflectance. The light guide member may include a first light guide portion positioned on a side close to the light exit surface of the reflection member, and a second light guide portion positioned on a surface of the reflection member opposite to the light exit surface of the reflection member. The second light guide portion may be integrally formed with and/or optically coupled to the first light guide portion. An index of refraction of the first light guide portion may be equal to, or greater, than that of the second light guide portion.

The size of each of the light exit holes on the light exit surface of the reflection member may be larger than that of each of the light exit holes on the surface of the reflection member opposite to the light exit surface.

Each of the light exit holes may have an inclined surface at an acute angle with respect to the light exit surface. Sidewalls of each of the light exit holes may have a reverse trapezoidal shape in which the light exit surface of the reflection member is longer than the surface of the reflection member opposite to the light exit surface.

The shape of each of the light exit holes at the light exit surface may be a closed loop or a polygon.

The light exit surface may be a simple mirror surface, a diffusive mirror surface or a directive reflection surface.

The index of refraction of the light guide member may not be lower (i.e., equal to, or greater) than that of the outside of the light exit surface.

An interval between adjacent light exit holes may correspond, or vary according, to a distance from a side surface on which light is incident to each respective light exit hole.

To achieve the above and/or other aspects, there is provided a display device including a light source, a light guide plate having a filled-in type light emitting structure to guide light emitted from the light source toward a light exit surface, the light guide plate including a transparent light guide member and a reflection member filled in the light guide member. The reflection member reflects light incident on the light guide member. The reflection member may have a plurality of light exit holes through which light reflected inside the light guide member exits, a reflection plate provided at a side of the light guide plate close to a surface opposite to the light exit surface of the light guide plate, and a display panel forming an image by modulating light exiting from the light guide plate.

The display panel may be a liquid crystal panel, a polymer dispersed liquid crystal panel, an electrowetting display panel or an electrochromic display panel.

The display device may be a transflective type.

According to example embodiments, there is provided a method of fabricating a light guide plate including providing a reflection member in which a plurality of light exit holes are formed, and filling the reflection member in a light guide member by providing a transparent material at a side surface of the reflection member and inside the light exit holes.

The light exit holes may be formed by an etching or punching process.

The light guide member may be formed by an injection method.

According to example embodiments, there is provided a method of fabricating a light guide plate, which includes providing a first light guide portion having a plurality of protrusion portions using a transparent material. A reflection film may be coated on a surface where the protrusion portions of the first light guide portion are formed. A portion of the reflection film, which is coated at an end portion of each of the protrusion portions of the first light guide portion, may be removed. A second light guide portion may be provided using a transparent material. The second light guide portion may be integrally formed with, or optically coupled to, the first light guide portion. The reflection film may be interposed between the first and second light guide portions.

Partial removal of the reflection film coated on the end portion of each of the protrusion portions of the first light guide portion may be performed by a planarization process, a chemical etching process or a rubbing process.

The first and second light guide portions may be formed by an injection method.

### BRIEF DESCRIPTION OF THE DRAWINGS

These and/or other aspects will become apparent and more readily appreciated from the following description of the embodiments, taken in conjunction with the accompanying drawings of which:

FIG. 1 is a perspective view of a light guide plate according to example embodiments;

FIG. 2 is a side sectional view of the light guide plate of FIG. 1;

FIG. 3 is a perspective view of a light guide plate according to example embodiments;

FIG. 4 is a side sectional view of the light guide plate of FIG. 3;

FIG. 5 is a side sectional view of a display device according to example embodiments;

FIGS. 6A and 6B illustrate that the display device of FIG. 5 on/off modulates external light and backlight light;

FIG. 7 is a side sectional view of a display device according to example embodiments;

FIG. 8 is a side sectional view of a display device according to example embodiments;

FIG. 9 is a side sectional view of a display device according to example embodiments;

FIG. 10 is a side sectional view of a display device according to example embodiments;

FIG. 11 is a side sectional view of a display device according to example embodiments;

FIG. 12 is a side sectional view of a display device according to example embodiments;

FIG. 13A-13C illustrate a method of fabricating a light guide plate according to example embodiments;

FIG. 14A-14C illustrate a method of fabricating a light guide plate according to example embodiments;

FIG. 15A-15D illustrate a method of fabricating a light guide plate according to example embodiments; and

FIG. 16A-16D illustrate a method of fabricating a light guide plate according to example embodiments.

### DETAILED DESCRIPTION OF EXAMPLE EMBODIMENTS

Various example embodiments will now be described more fully with reference to the accompanying drawings in which some example embodiments are shown. However, specific structural and functional details disclosed herein are merely representative for purposes of describing example embodiments. Thus, the invention may be embodied in many alternate forms and should not be construed as limited to only example embodiments set forth herein. Therefore, it should be understood that there is no intent to limit example embodiments to the particular forms disclosed, but on the contrary, example embodiments are to cover all modifications, equivalents, and alternatives falling within the scope of the invention.

In the drawings, the thicknesses of layers and regions may be exaggerated for clarity, and like numbers refer to like elements throughout the description of the figures.

Although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that, if an element is referred to as being “connected” or “coupled” to another element, it can be directly connected, or coupled, to the other element or intervening elements may be present. In contrast, if an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” if used herein, specify the presence of stated features, integers, steps, operations, elements and/or components, but do not preclude the presence or addition of one or more other features, integers, steps, operations, elements, components and/or groups thereof.

Spatially relative terms (e.g., “beneath,” “below,” “lower,” “above,” “upper” and the like) may be used herein for ease of description to describe one element or a relationship between a feature and another element or feature as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, for example, the term “below” can encompass both an orientation that is above, as well as, below. The device may be otherwise oriented (rotated 90 degrees or viewed or referenced at other orientations) and the spatially relative descriptors used herein should be interpreted accordingly.

Example embodiments are described herein with reference to cross-sectional illustrations that are schematic illustrations of idealized embodiments (and intermediate structures). As such, variations from the shapes of the illustrations as a result, for example, of manufacturing techniques and/or tolerances, may be expected. Thus, example embodiments should not be construed as limited to the particular shapes of regions illustrated herein but may include deviations in shapes that result, for example, from manufacturing. For example, an implanted region illustrated as a rectangle may have rounded or curved features and/or a gradient (e.g., of implant concentration) at its edges rather than an abrupt change from an implanted region to a non-implanted region. Likewise, a buried region formed by implantation may result in some implantation in the region between the buried region and the surface through which the implantation may take place. Thus, the regions illustrated in the figures are schematic in nature and their shapes do not necessarily illustrate the actual shape of a region of a device and do not limit the scope.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

In order to more specifically describe example embodiments, various aspects will be described in detail with reference to the attached drawings. However, the present invention is not limited to example embodiments described.

Example embodiments relate to light guide plates having a filled-in type light emitting structure, display apparatuses using a light guide plate and methods of fabricating the same.

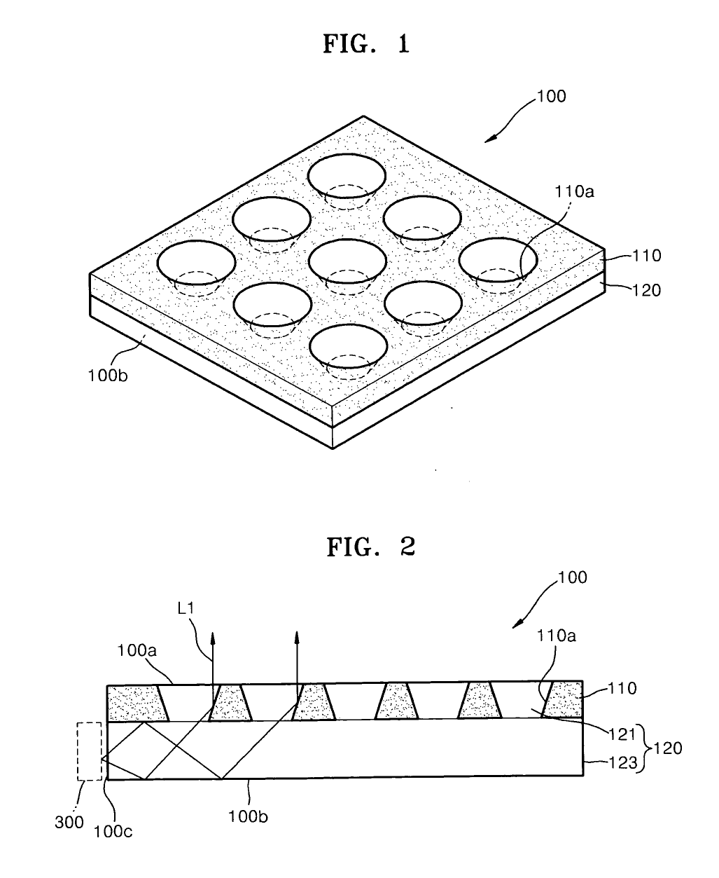

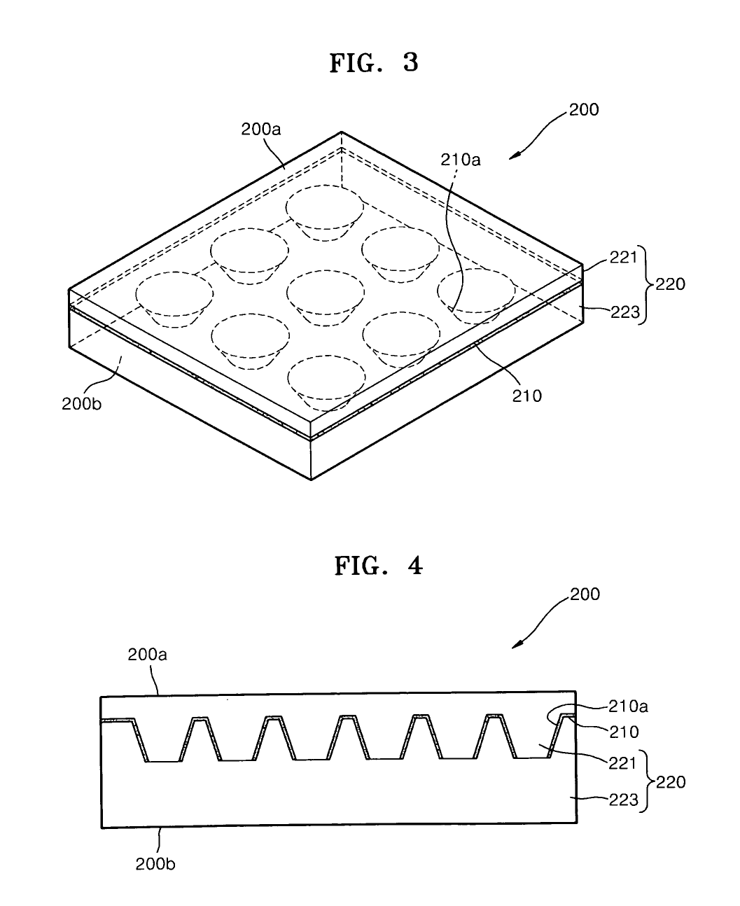

FIG. 1 is a perspective view of a light guide plate according to example embodiments. FIG. 2 is a side sectional view of the light guide plate shown in FIG. 1.

Referring to FIGS. 1 and 2, a light guide plate 100 includes a reflection plate 110, and a light guide member 120 in which the reflection plate 110 is filled. The reflection plate 110 is a reflection member that reflects light travelling inside the light guide member 120. The reflection plate 110 is filled at one side of the light guide member 120. The reflection plate 110 may be formed of a metal (or a non-metal) having a substantially high reflectance, or by coating a metal (or a non-metal) having a substantially high reflectance on a plastic material having a substantially low reflectance.

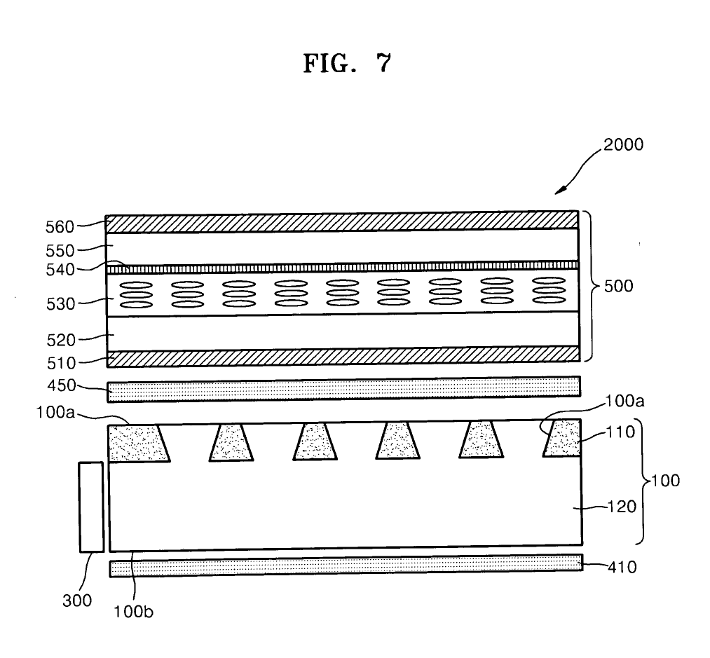

An upper surface of the reflection plate 110 may be a light exit surface 100a of the light guide plate 100 (hereinafter referred to as a “light exit surface”). The light exit surface 100a may be a simple mirror surface, a diffusive reflection surface or a directive reflection surface. The simple mirror surface denotes that, for example, the upper surface of the reflection plate 110 is formed smooth. The diffusive reflection surface denotes that, for example, a diffusion pattern diffusively reflecting incident light is formed on the upper surface of the reflection plate 110. The directive reflection surface denotes that, for example, a diffraction pattern designed to have a substantially high diffraction efficiency in a particular direction is formed on the upper surface of the reflection plate 110. If the upper surface of the reflection plate 110 is the diffusive reflection surface or the directive reflection surface, the possibility of an image formed by a display panel (e.g., the display panel 500 shown in FIG. 5) appearing in two tiers as a result of being reflected by the reflection plate 110 may be reduced.

The reflection plate 110 has a plurality of light exit holes 110a through which light L1 reflected inside the light guide member 120 is output. Each of the light exit holes 110a may be formed such that, for example, the size of each of the light exit holes 110a close to the light exit surface 100a can be larger than that of each of the light exit holes 110a close to a surface opposite to the light exit surface 100a. A side wall of each of the light exit holes 110a may have an inclined surface which is at an acute angle with respect to the light exit surface 100a. For example, the side section of each of the light exit holes 110a may have a reverse trapezoidal shape in which a side along the light exit surface 100a is longer than that along a surface opposite to the light exit surface 100a.

Each of the light exit holes 110a at the light exit surface 100a has, for example, a looped curve or polygonal shape (e.g., a circular shape, an oval shape, a rectangular shape or a hexagonal shape). The interval between the light exit holes 110a may correspond, or vary according, to the distance from a side surface on which light incident (hereinafter referred to as a “light incident surface 100c”) to the respective light exit hole 110a. For example, to make the luminance of light output from the light guide plate 100 uniform, the interval between the light exit holes 110a decreases (to be more dense), as the light exit holes 110a are located farther from the light incident surface 100c. The size of each of the light exit holes 110a may vary according to the distance from the light incident surface 100c. For example, the size of each of the light exit holes 110a may increase as the light exit holes 110a are located farther from the light incident surface 100c. Because the light exit holes 110a are filled with a transparent material (as described later) to form a light exit portion 121, the shape, interval and size of the light exit holes 110a define those of the light exit portion 121. The shape, interval and size of the light exit holes 110a of FIGS. 1 and 2 are examples, and therefore above embodiments are not limited thereto. The shape, interval and size of the light exit holes 110a may be appropriately designed according to the light-emitting characteristic of a light source 300 or the light exit characteristic required for the light guide plate 100.

The light guide member 120 includes the light exit portion 121 filling the light exit holes 110a of the reflection plate 110 and a light guide portion 123 provided at the lower surface of the reflection plate 110. The light guide portion 123 is provided on the surface opposite to the light exit surface 100a of the reflection plate 110. The light exit portion 121 and the light guide portion 123 may be integrally formed by an injection process. The reflection plate 110 may be attached to the light guide portion 123. The light exit holes 110a are filled with a transparent material. The light exit portion 121 and the light guide portion 123 may be formed of different materials. If the light exit portion 121 and the light guide portion 123 are formed of different materials, the light exit portion 121 and the light guide portion 123 may be optically coupled to each other by selecting a material wherein the index of refraction of the light exit portion 121 is equal to, or greater, than that of the light guide portion 123. Optical coupling means that light passes through a boundary between the light exit portion 121 and the light guide portion 123, substantially without any loss of light. Although the light guide member 120 does not cover the upper surface of the reflection plate 110 (or the light exit surface 100a), example embodiments are not limited thereto. For example, if the light exit holes 110a are filled with a transparent material, the upper surface of the reflection plate 110 is coated with the transparent material so that the reflection plate 110 may be completely filled in the light guide member 120.

The light guide member 120 may be formed of a transparent material having a reflectance higher than that of an external environment (e.g., air). The light guide member 120 may be formed of a material such as poly(methy methacrylate) (PMMA) or polycarbonate (PC), which are hard molds having substantially high transmissivity and/or durability. The light guide member 120 may be formed of a soft mold that is transparent and flexible (e.g., silicone rubber or polydimethylsiloxane (PDMS)) so that the light guide plate 100 may be flexible. If the light guide plate 100 is flexible, the light guide plate 100 may be used in a flexible display device as described later. Example embodiments are not limited to the above-described materials of the light guide member 120.

The light exit portion 121 is provided in each of the light exit holes 110a, through which the light L1 output from the light source 300 and guided by the light guide portion 123 exits. In the light guide plate 100, because the light exit portion 121 is provided in each of the light exit holes 110a, the light exit portion 121 may not be damaged by external shock.

As described above, the shape, interval and size of the light exit portion 121 may be appropriately designed according to the light exit characteristic of the light source 300 or the light exit characteristic required for the light guide plate 100. For example, as illustrated in FIG. 1, a side section the light exit portion 121 has a reverse trapezoidal shape in which a side at the light exit surface 100a is longer than a side at a surface opposite to the light exit surface 100a so that the size of the light exit portion 121 close to the light exit surface 100a may be larger than that of the light exit portion 121 close to the light guide portion 123.

A functional structure (e.g., a light guide bar (LGB)) or a serration pattern may be formed at a side surface of the light guide portion 123. The light guide portion 123 guides the light incident on the light incident surface 100c located at the side surface of the light guide portion 123. Most of the light output from the light source 300 and proceeding toward the light incident surface 100c may be incident at an angle smaller than a critical angle for total reflection. Most of the light input to the inside of the light guide portion 123 may be totally reflected by a bottom surface 100b of the light guide portion 123 opposite to the light exit surface 100a of the light guide plate 100. The light input to the inside of the light guide portion 123 may be reflected by the lower surface of the reflection plate 110.

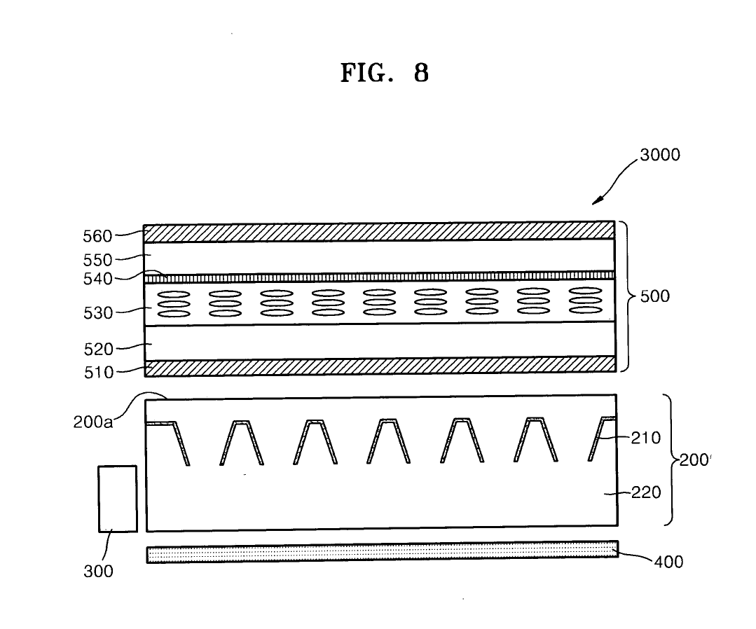

The light input to the inside of the light guide portion 123 is guided to the entire space of the inside of the light guide portion 123 by being totally reflected due to a difference in the index of refraction or by being reflected from the reflection plate 110. Of the light guided in the light guide portion 123, the light L1 proceeding toward the light exit portion 121 is externally output directly, or by being reflected by a side wall of each of the light exit holes 110a. The external light incident on the light exit portion 121 (see Lf of FIG. 6A) may penetrate the light exit portion 121 and the light guide portion 122.

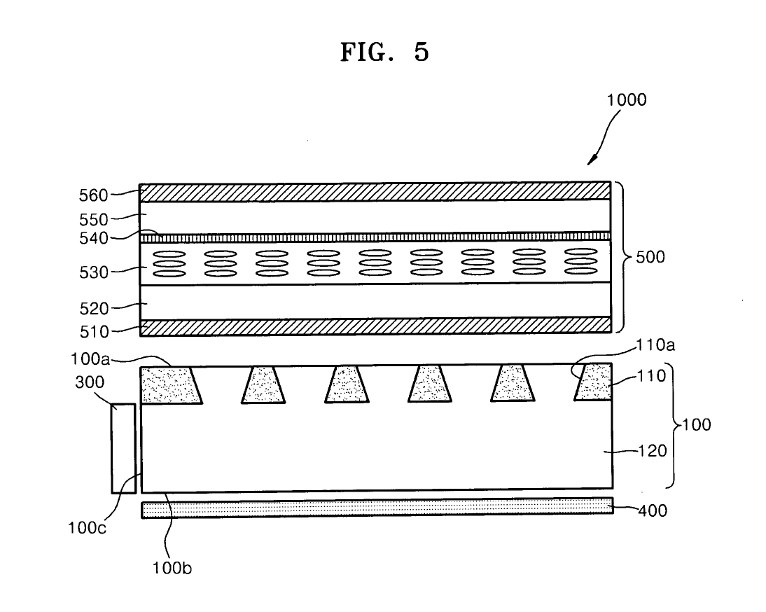

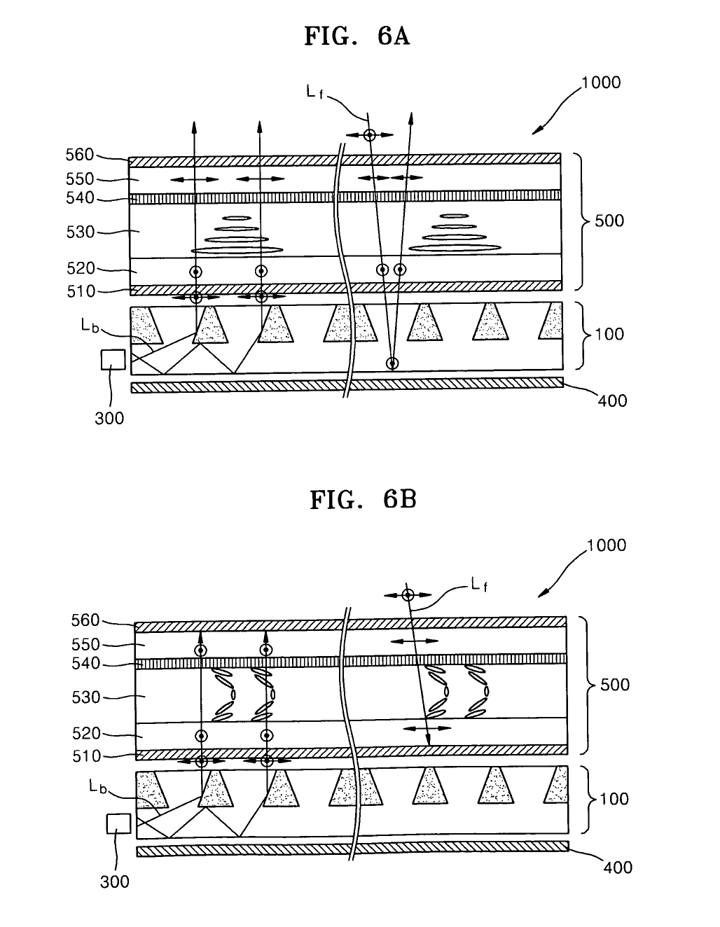

FIG. 3 is a perspective view of a light guide plate according to example embodiments. FIG. 4 is a side sectional view of the light guide plate shown in FIG. 3.

Referring to FIGS. 3 and 4, the light guide plate 200 of example embodiments include a reflection film 210 and a light guide member 220 in which the reflection film 210 is inserted.

The reflection film 210 is a reflection member for reflecting light input to the inside of the light guide member 220. The light guide member 220 includes a first light guide portion 221 and a second light guide portion 223. The reflection film 210 is inserted between the first and second light guide portions 221 and 223. The reflection film 210 may be formed by coating a metal, or a non-metal, having a substantially high reflectance on the first or second light guide portion 221 or 223. The upper surface of the reflection film 210 (i.e., the surface close to a light exit surface 200a of the first light guide portion 221) may be a simple mirror surface, a diffusive reflection surface or a directive reflection surface.

The reflection film 210 has a plurality of light exit holes 210a that allow light reflected inside the light guide member 220 to exit externally. The light exit holes 210a may be formed such that, for example, the size of each of the light exit holes 210a close to the light exit surface 200a can be larger than that of each of the light exit holes 210a close to a surface opposite to the light exit surface 200a. The reflection film 210 is inclined with respect to the light exit surface 200a at the light exit holes 210a forming a side wall of each of the light exit holes 210a. The side wall of the light exit holes 210a may be formed at an acute angle with respect to the light exit surface 200a. For example, the side section of each of the light exit holes 210a may have a reverse trapezoidal shape in which a side at the light exit surface 200a is longer than a side at a surface opposite to the light exit surface 200a. The above shape, interval and size of the light exit holes 210a of FIGS. 3 and 4 are examples, and therefore example embodiments are not limited thereto. The shape, interval and size of the light exit holes 210a may be appropriately designed according to the light exit characteristic of the light source 300 or the light exit characteristic required for the light guide plate 200.

The light guide member 220 includes the first light guide portion 221 provided at one surface of the reflection film 210 and the second light guide portion 223 provided at the other surface of the reflection film 210. For convenience of explanation, a light guide portion close to the light exit surface 200a is referred to as the first light guide portion 221. A portion of the first light guide portion 221 close to each of the light exit holes 210a is a light exit portion of the second light guide portion 223. The first and second light guide portions 221 and 223 may be formed by a two-step injection process as described later. A diffusion pattern, or a directive diffraction pattern, may be formed on the upper surface of the first light guide portion 221 (the light exit surface 200a).

The first and second light guide portions 221 and 223 may be integrally formed of the same, or different materials, and then optically coupled to each other. Example embodiments are not limited to the above-described material of the light guide member 220. As described above, the light guide member 220 may be formed of a hard mold having substantially high transmissivity and durability, or a soft mold that is transparent and flexible. If the first and second light guide portions 221 and 223 are formed of different materials, the first and second light guide portions 221 and 223 may be optically coupled to each other by selecting a material wherein the index of refraction of the first light guide portion 221 is equal to, or greater than, that of the second light guide portion 223.

The light source 300 (see FIG. 2) is arranged at a side surface of the second light guide portion 223. The light output from the light source 300 and incident on the side surface of the second light guide portion 223 is guided to the entire space inside of the second light guide portion 223 by being totally reflected due to a difference in the index of refraction, or by being reflected from the reflection plate 110. Of the light guided in the second light guide portion 223, the light proceeding towards the light exit holes 210a is externally output directly, or by being reflected by a side wall of each of the light exit holes 210a. The external light incident on the light exit surface 200a may penetrate the first and second light guide portions 221 and 223 via the light exit holes 210a.

FIG. 5 is a side sectional view of the display device according to example embodiments.

Referring to FIG. 5, a display device 1000 includes a backlight unit and a display panel 500. The backlight unit includes the light source 300, the light guide plate 100 and a rear reflection plate 400. Because the light guide plate 100 is described with reference to FIGS. 1 and 2, a detailed description thereof will be omitted herein.

The light source 300 is provided at a side of the light guide plate 100. A point light source (e.g., a light emitting diode (LED)) or a linear light source (e.g., a cold cathode fluorescent lamp (CCFL)) may be used as the light source 300. A plurality of point light sources may be used, or a device for converting a point light to a linear light may be used with the point light source.

The rear reflection plate 400 is provided at the surface 100b of the light guide plate 100 opposite to the light exit surface 100a. The rear reflection plate 400 is provided to reflect external light input through the light exit holes 110a. The rear reflection plate 400 may help the light output from the light source 300 to be reflected in the light guide member 120. Most of the light output from the light source 300 has an incident angle that is totally reflected when arriving at the bottom surface 100b of the light guide member 120. Part of the light is incident on the bottom surface 100b of the light guide member 120 at an angle greater than the total reflection critical angle so that the part of the light passes through the bottom surface of the light guide member 120. The light passing through the bottom surface of the light guide member 120 is reflected by the rear reflection plate 400 into the light guide member 120.

A diffusive reflection plate on which a set diffusion pattern is formed, or a directive reflection plate on which a set diffraction pattern is formed, may be used as the rear reflection plate 400. The diffusive reflection plate, or the directive reflection plate, may reduce the possibility of an image formed by the display panel 500 appearing in two tiers as a result of being reflected by the rear reflection plate 400.

The display panel 500 forms an image by modulating light output from the light guide plate 100. In example embodiments, the display panel 500 is, for example, a liquid crystal panel. The display panel 500 includes first and second substrates 520 and 550, and a liquid crystal layer 530 interposed between the first and second substrates 520 and 550. The first and second substrates 520 and 550 are transparent substrates. For example, the first and second substrates 520 and 550 may be a glass substrate. First and second polarizers 510 and 560 are respectively provided at outer surfaces of the first and second substrates 520 and 550, respectively. The polarization axes of the two polarizers 510 and 560 may perpendicularly cross each other. A color filter 540 to represent color is provided on an inner surface of the second substrate 550. Although not illustrated in FIG. 5, a pixel electrode, a TFT layer and other components may be provided to control the liquid crystal layer 530 corresponding to each pixel.

FIGS. 6A and 6B illustrate that the display device of FIG. 5 on/off modulates external light L_{f} and light L_{b} from the backlight unit. The display device shown in FIGS. 6A and 6B is transflective. The operation of the display device will be described below with reference to FIGS. 6A and 6B.

Referring to FIG. 6A, the light output from the light source 300 is guided by the light guide plate 100 to proceed toward the display panel 500. The polarization of the light proceeding toward the display panel 500 is changed to a first polarization state by the first polarizer 510. If an electric field is not applied to the liquid crystal layer 530, the polarization of the light L_{B} incident on the liquid crystal layer 530 is changed to a second polarization state that is perpendicular to the first polarization state, while passing through the liquid crystal layer 530. While passing through the color filter 540, the light L_{B} in the second polarization state has color corresponding to the color filter 540. The second polarizer 560 transmits the light L_{B} of the second polarization state, thereby forming a pixel-on state.

The external light L_{f} incident on the front surface of the display panel 500 functions as an image forming light as follows. While passing through the second polarizer 560, the polarization state of the external light L_{f} is changed to the second polarization state. While passing through the liquid crystal layer 530 to which an electric field is not applied, the polarization state of the external light L_{f} is changed to the first polarization state. The external light L_{f} passes through the first polarizer 510 that transmits the light of the first polarization state. The external light L_{f} is incident on the light guide plate 100 and is reflected by the rear reflection plate 400 to proceed toward the display panel 500. The external light L_{f} passes through the first polarizer 510, the liquid crystal layer 530, the color filter 540 and the second polarizer 560, thereby forming a pixel-on state that represents color corresponding to the color filter 540.

FIG. 6B illustrates a state in which an electric field is applied to the liquid crystal layer 530. In FIG. 6B, liquid crystal molecules are oriented in a direction of the electric field so that the polarization of the light passing through the liquid crystal layer 530 may not be changed. The light that is output from the light source 300, incident on the light guide plate 100, and output toward the display panel 500 passes through the first polarizer 510 so that the polarization of the light may be changed to the first polarization state. While passing through the liquid crystal layer 530, the light maintains the first polarization state. The light does not pass through the second polarizer 560, thereby forming a pixel-off state. If the external light L_{f} passes through the second polarizer 560, the polarization of the external light L_{f} is changed to the second polarization state. While passing through the liquid crystal layer 530, the external light L_{f} maintains its polarization state. The external light L_{f} is absorbed by the first polarizer 510 so that a pixel-off state may be formed.

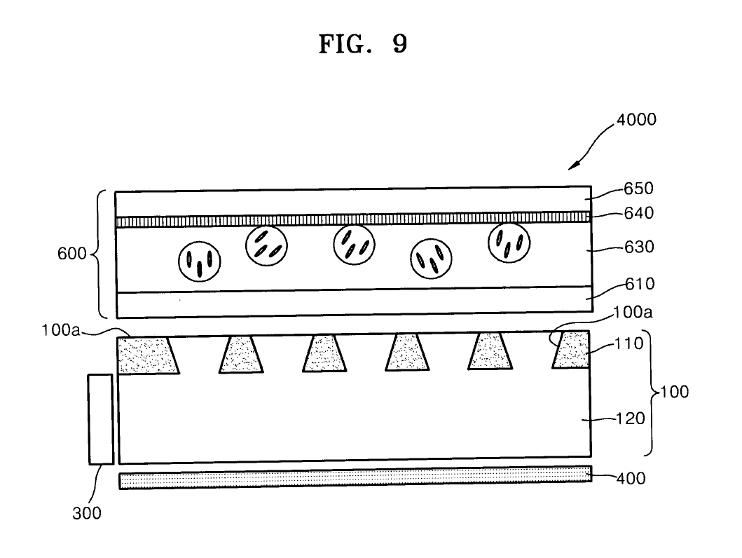

FIG. 7 is a side sectional view of a display device according to example embodiments.

Referring to FIG. 7, a display device 2000 according to example embodiments includes a backlight unit and the display panel 500. The backlight unit includes the light source 300, the light guide plate 100, a rear reflection plate 410 and a diffusion plate 450.

A simple mirror may be used as the rear reflection plate 410. The diffusion plate 450 is provided between the light guide plate 100 and the display panel 500. A diffusion pattern may be formed, or a plurality of particles generating diffusion may be distributed, on a surface of the diffusion plate 450. The diffusion plate 450 reduces the possibility of an image formed by the display panel 500 appearing in two tiers by being reflected by the rear reflection plate 410. The display device 2000 is different from the display device 1000 shown in FIG. 5 in that the diffusion plate 450 is provided as well as the rear reflection plate 410 of a simple mirror type.

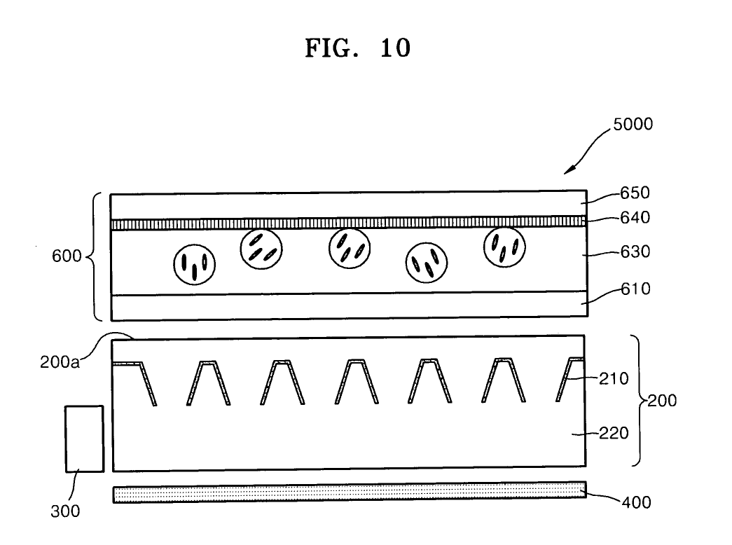

FIG. 8 is a side sectional view of a display device 3000 according to example embodiments.

Referring to FIG. 8, the display device 3000 according to example embodiments includes a backlight unit and the display panel 500. The backlight unit includes the light source 300, a light guide plate 200 and the rear reflection plate 400. The display device 3000 is different from the display device 1000 of FIG. 5 in that the light guide plate 200 is formed of a light guide member 200 in which a reflection film 210 is inserted. The light guide plate 200 is described with respect to FIGS. 3 and 4. Although in example embodiments a diffusive or directive type rear reflection plate is used as the rear reflection plate 400, the diffusive plate 450 of FIG. 7 may be interposed between the light guide plate 200 and the display panel 500, instead of using the rear reflection plate 400 of a simple mirror type.

As described above, the light guide plate 200 guides the light emitted from the light source 300 that is arranged at a side of the light guide plate 200, to proceed toward the display panel 500. An external light input from the display panel 500 penetrates the light guide plate 200 and is reflected by the rear reflection plate 400. The reflected external light penetrates the light guide plate 200 again, and is input to the display panel 500. The display device 3000 is a transflective type, which forms an image using both of the light of the backlight unit and the external light as light.

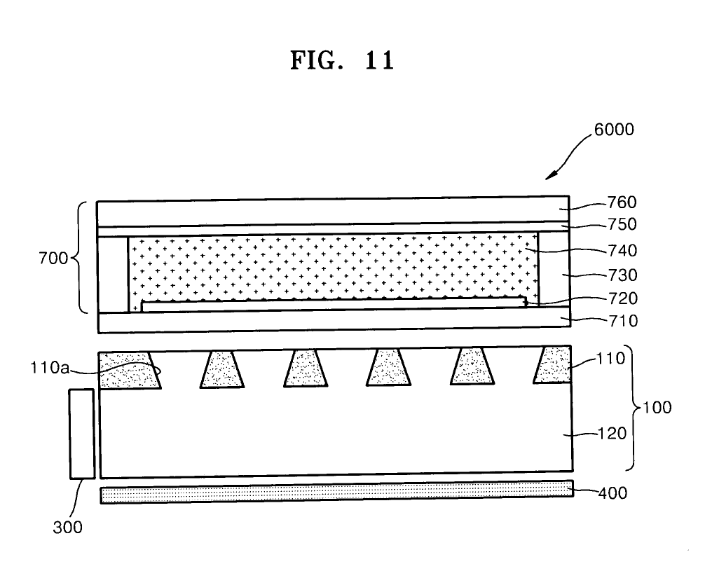

FIG. 9 is a side sectional view of a display device according to example embodiments.

Referring to FIG. 9, a display device 4000 includes a backlight unit and a display panel 600. The backlight unit includes the light source 300, the light guide plate 100 and the rear reflection plate 400. The display device 4000 is different from the display device 1000 of FIG. 5 in that a polymer dispersed liquid crystal (PDLC) panel is used as the display panel 600. Although a diffusive or directive type rear reflection plate is used as the rear reflection plate 400, the diffusion plate 450 of FIG. 7 interposed between the light guide plate 200 and the display panel 600 as well as the simple mirror type rear reflection plate 410 of FIG. 7 may be used.

The display panel 600 is a PDLC panel having a PDLC layer 630 provided between the first and second substrates 610 and 650 and formed by mixing black dye into the PDLC. A color filter 640, to represent (or determine) color, is provided on an inner surface of the second substrate 650. Although it is not illustrated, a pixel electrode, a TFT layer and other components may be provided to control the PDLC layer 630 corresponding to each pixel. In the PDLC, if an electric field is not applied, incident light is diffused due to a difference in permittivity between the polymer and the liquid crystal. If the electric field is applied, as the difference in permittivity between the polymer and the liquid crystal that is oriented according to the electric field decreases, the PDLC becomes transparent to transmit light. In the PDLC in which black dye is mixed, if the PDLC diffuses light in the state in which an electric field is not applied, the black dye absorbs the light. If the electric field is applied, the PDLC transmits the light. As such, an “on/off” state of a pixel may be implemented. Because the above structure does not use polarization of light, a polarization plate is not needed unlike a general liquid crystal panel. Because the PDLC is dispersed and fixed in the PDLC layer 630, the display panel 600 may be formed in a flexible structure. As described above, because the light guide plate 100 may be formed to be flexible, the display device 4000 may be formed to be flexible.

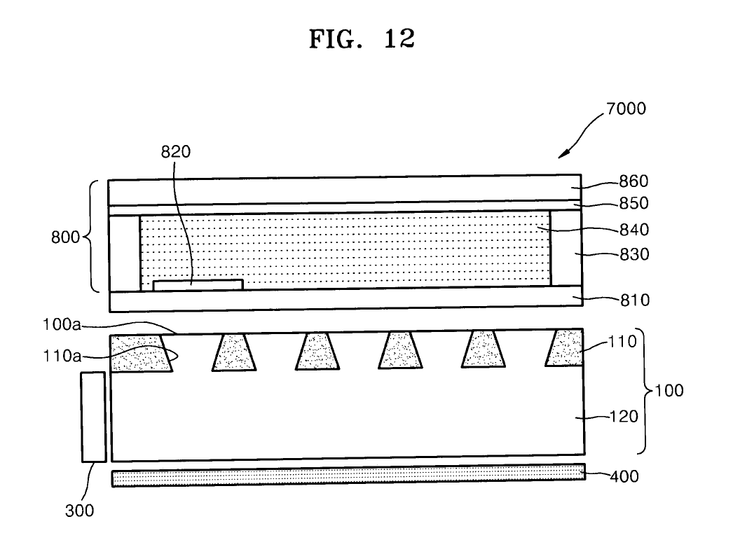

FIG. 10 is a side sectional view of a display device according to example embodiments.

Referring to FIG. 10, a display device 5000 includes a backlight unit and the display panel 600. The backlight unit includes the light source 300, the light guide plate 200 and the rear reflection plate 400. The display device 5000 is different from the display device 4000 of FIG. 9 in that the light guide plate 200, which has the light guide member 220 in which the reflection film 210 is inserted, is used. The light guide plate 200 is described with reference to FIGS. 3 and 4.

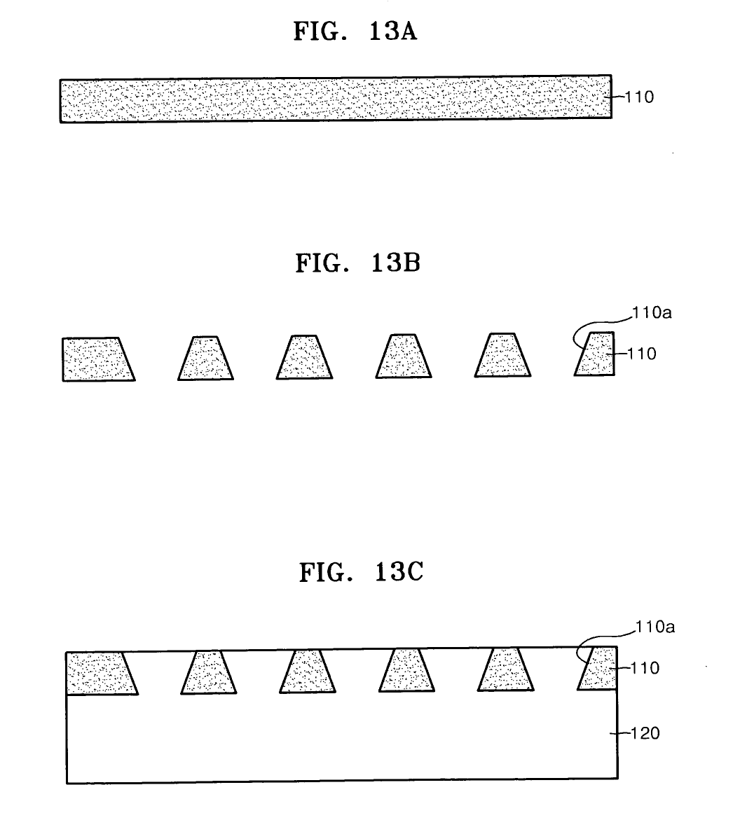

FIG. 11 is a side sectional view of a display device according to example embodiments.

Referring to FIG. 11, a display device 6000 includes a backlight unit and the display panel 700. The backlight unit includes the light source 300, the light guide plate 100 and the rear reflection plate 400. The display device 6000 is different from the display device 4000 of FIG. 9 in that an electrochromic display panel is used as the display panel 700. The light guide plate 200 described with reference to FIGS. 3 and 4 may be used instead of the light guide plate 100 formed of the light guide member 120 in which the reflection plate 110 is filled.

The display panel 700 is an electrochromic display panel including a transparent partition 730 sectioning (or dividing) a space between first and second substrates 710 and 760, and an electrochromic layer 740 provided in a space formed by the transparent partition 730. The electrochromic layer 740 may be formed by, for example, mixing an electrochromic material in an electrolyte. The electrochromic material changes color according to electrons or holes. If an electric field is applied by mixing an electrochromic material in an electrolyte, color may be generated, or not be generated, as the electrons or holes are coupled to the electrochromic material. Transparent electrode layers 720 and 750 to which a voltage is applied to form an electric field in the electrochromic layer 740 are respectively formed on the surfaces of the first and second substrates 710 and 760 facing the electrochromic layer 740.

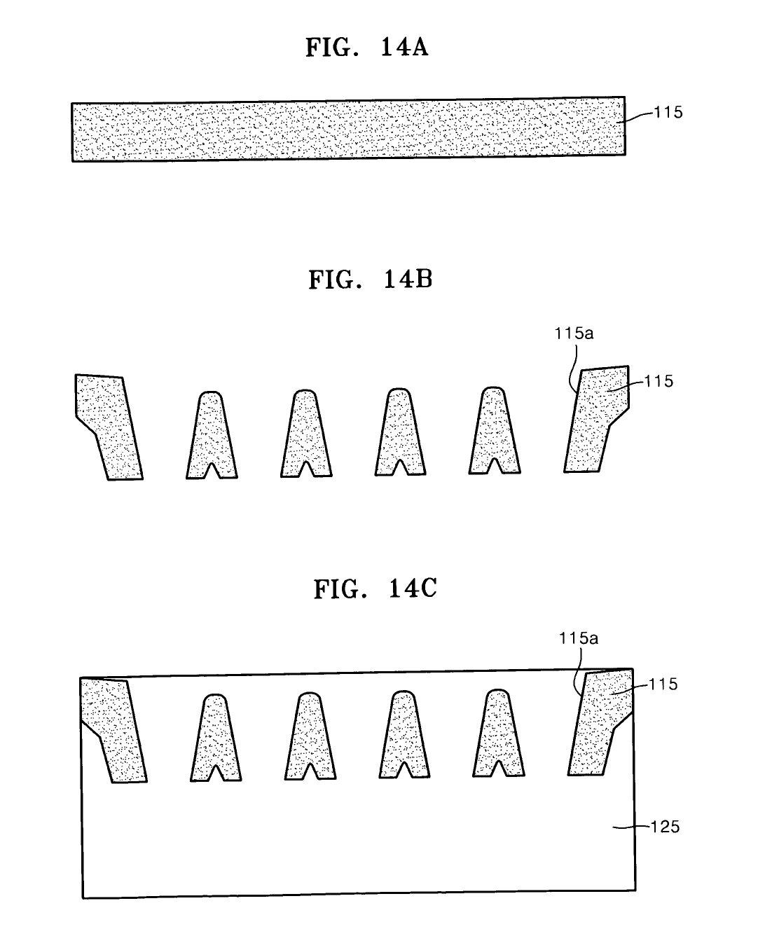

FIG. 12 is a side sectional view of a display device according to example embodiments.

Referring to FIG. 12, a display device 7000 includes a backlight unit and the display panel 800. The backlight unit includes the light source 300, the light guide plate 100 and the rear reflection plate 400. The display device 7000 is different from the display device 6000 of FIG. 11 in that an electrowetting display panel is used as the display panel 800. The display panel 800 is an electrowetting display panel that includes a transparent partition 830 sectioning a space between first and second substrates 810 and 960 and an electrowetting layer 840 provided in a space formed by the transparent partition 830.

Electrowetting denotes that a liquid substance uniformly disperses, or is concentrated, at a side as the surface tension of a boundary surface changes according to electric charges existing on the boundary surface. The liquid substance that is mixed with dye or pigment for coloring is used as a display device. Transparent electrode layers 820 and 850 to which a voltage is applied to form an electric field in the electrowetting layer 840 are formed on the surfaces of the first and second substrates 810 and 860 facing the electrowetting layer 840.

The display devices 1000, 2000, 3000, 4000, 5000, 6000 and 7000 described with reference to FIGS. 5-12 all have a transflective structure capable of using the backlight light L_{b} and the external light L_{f} as an image forming light, by including the light guide plates 100 and 200 having a fill-in type light emitting structure which allows the light L_{b} of the light source 100 to proceed toward the display panels 500, 600, 700 and 800 and reflects the external light L_{f} incident on the front surface of each of the display panels 500, 600, 700 and 800 to proceed toward the display panels 500, 600, 700 and 800. The light guide plates 100 and 200 according to example embodiments may be applied to a transmissive display device. In addition to the above-described display panels, electrophoresis display panels, or MEMS shutters, may be used as the display panel. As described above, the light exit holes 110a and 210a may be formed in a variety of shapes and distributions in the light guide plates 100 and 200 having a filled-in light emitting structure.

A method of fabricating the light guide plates according to example embodiments will be described below.

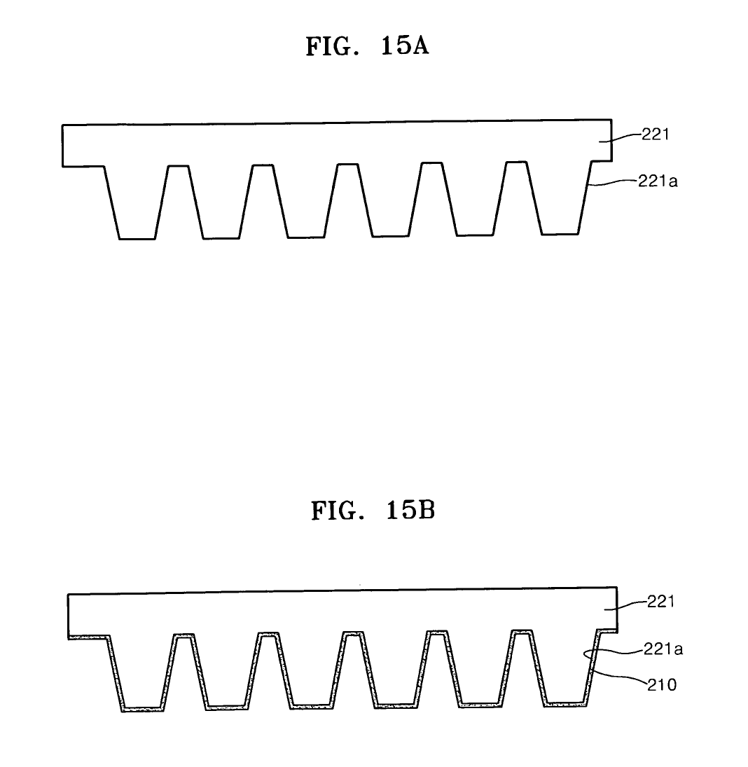

FIG. 13A-13C illustrate a method of fabricating a light guide plate according to example embodiments.

Referring to FIG. 13A, the reflection plate 110 is prepared. The reflection plate 110 may be formed of a metal, or a non-metal, having a substantially high reflectance, or by coating a metal or a non-metal having a substantially high reflectance on a plastic material having a substantially low reflectance.

Referring to FIG. 13B, a plurality of through holes 110a are formed in the reflection plate 110. The light exit holes 110a may be formed by a chemical etching process. The shape, interval and size of the light exit holes 110a may be appropriately designed according to the optical requirements. After the light exit holes 110a are formed, a substantially high reflectance coating layer (not shown) may be formed on the surface of the reflection plate 110. For example, a high reflectance coating layer may be formed by depositing multiple layers of self-assembled monolayer (SAM) having different indexes of refraction.

Referring to FIG. 13C, the reflection plate 110 in which the light exit holes 110a are formed is filled in the light guide member 120 of a transparent material. The light guide member 120, for example, may be formed by an injection process. The light guide member 120 may be formed of a hard mold, or a soft mold, as described above.

In example embodiments, as the reflection plate 110 is filled in the light guide member 120, the light guide member 120 having a light exit portion may be smoothly formed by an injection process. The light guide member 120 may have a reverse trapezoidal shape. Because the light exit portion of the light guide member 120 is formed in the injection process filling the light exit holes 110a, the shape of the light exit portion may be easily changed by changing the shape of the light exit holes 110a. A functional structure (e.g., a light guide bar (LGB)) or a serration pattern may be formed at a side surface of the light guide member 120 in the injection process.

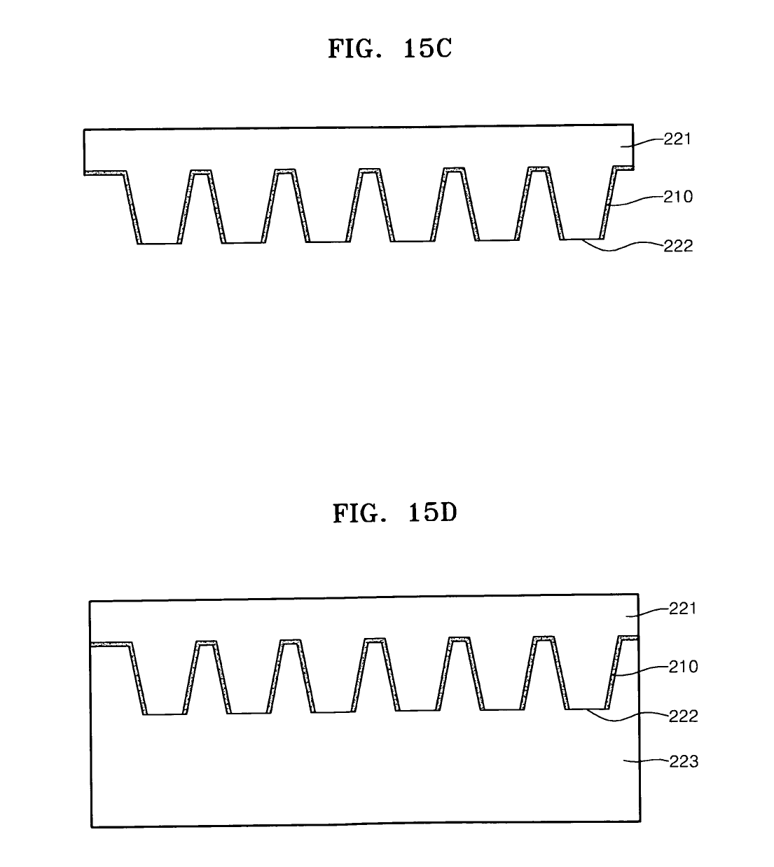

FIG. 14A-14C illustrate a method of fabricating a light guide plate according to example embodiments.

Referring to FIG. 14A, a reflection plate 115 is prepared. The reflection plate 115 may be formed of a metal (or a non-metal) having a substantially high reflectance or by coating a metal (or a non-metal) having a substantially high reflectance on a plastic material having a substantially low reflectance.

Referring to FIG. 14B, a plurality of through holes 115a (light exit holes 115a) are formed in the reflection layer 115. The light exit holes 115a may be formed by, for example, a mechanical punching process. The reflection plate 115 may be formed of a material having flexibility. An inclined surface may be formed during the punching process as the reflection plate 115 is pushed at the side near the light exit holes 115a. The shape, interval and size of the light exit holes 115a may be appropriately designed according to the optical requirements.

Referring to FIG. 14C, the reflection plate 115, in which the light exit holes 115a are formed, is filled in a light guide member 125 of a transparent material. The light guide member 125, for example, may be formed by an injection process. The light guide member 125 may be formed of a hard mold, or a soft mold, as described above.

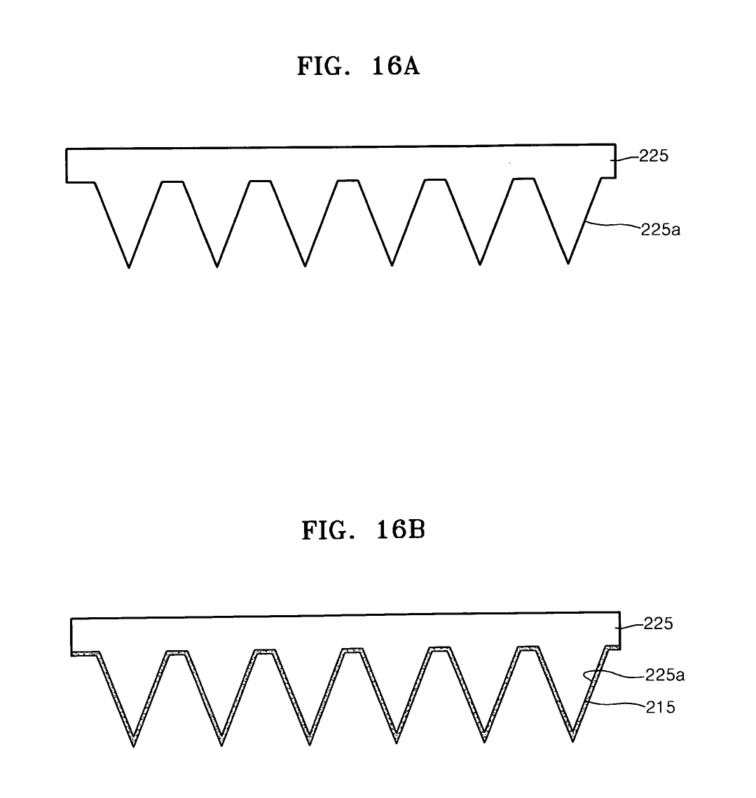

FIG. 15A-15D illustrate a method of fabricating a light guide plate according to example embodiments.

Referring to FIG. 15A, the first light guide portion 221 having a plurality of protrusion portions 221a is formed of a transparent material. Each of the protrusion portions 221a may have a side section of a reverse trapezoidal shape as illustrated in FIG. 15A. The first light guide portion 221 may be formed by, for example, an injection process.

Referring to FIG. 15B, the reflection film 210 may be formed by coating a metal, or a non-metal, having a substantially high reflectance on the surface of the first light guide portion 221 where the protrusion portions 221a are formed. For example, the reflection film 210 may be formed of aluminium (Al). The reflection film 210 may be formed into a metal thin film by using a film forming method (e.g., sputtering, evaporation, plating or a similar method).

Referring to FIG. 15C, an open area 222 is formed in the first light guide portion 221 by removing the reflection film 210 coated at the end portion of each of the protrusion portions 221a. The partial removal of the reflection film 210 coated at the end portion of each of the protrusion portion 221a may be performed by a planarization process (e.g., a chemical mechanical polishing (CMP) process, a chemical etching process, a rubbing process or similar process).

Referring to FIG. 15D, a second light guide portion 223 is formed of a transparent material integrally formed with, or optically coupled to, the first light guide portion 221 with the reflection film 210 interposed between the first light guide portion 221 and the second light guide portion 223. The second light guide portion 223 may be formed by an injection process.

In example embodiments, the light guide member is formed by an injection process that is performed twice. The first and second light guide portions 221 and 223 may be formed of the same material, or different materials, such that the index of refraction of the first light guide portion 221 may be not lower than that of the second light guide portion 223.

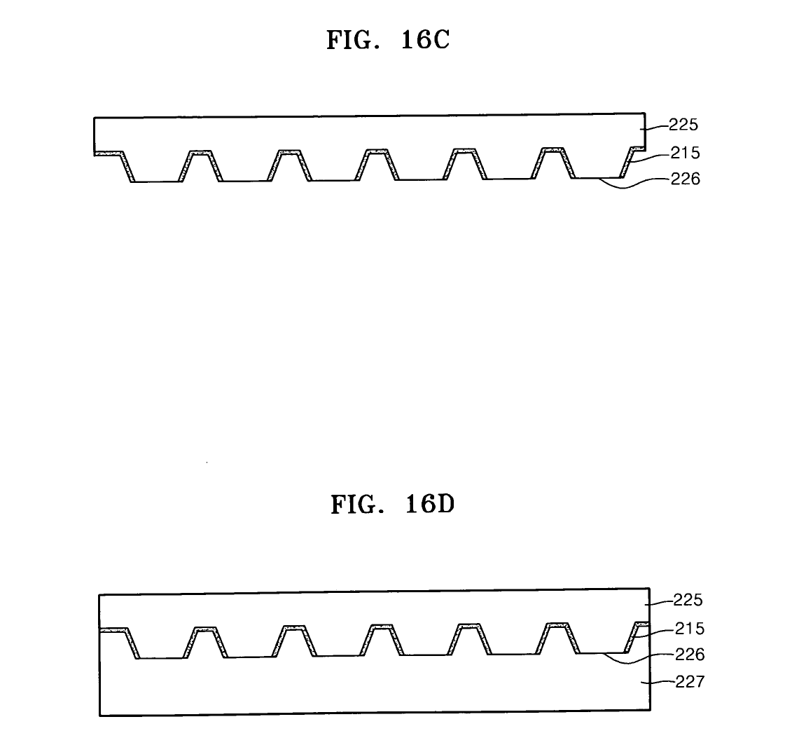

FIG. 16A-16D illustrate a method of fabricating a light guide plate according to example embodiments.

Referring to FIG. 16A, the first light guide portion 221 having a plurality of protrusion portions 225a formed of a transparent material is provided. Each of the protrusion portions 225a may have a side section having a reverse trapezoidal shape as illustrated in FIG. 16A. The first light guide portion 225 may be formed by, an injection process.

Referring to FIG. 16B, a reflection film 215 is formed by coating a metal, or a non-metal, having a substantially high reflectance on the surface of the first light guide portion 225 where the protrusion portions 225a are formed. The reflection film 215 may be formed by using a film forming method (e.g., sputtering, plating or a similar method).

Referring to FIG. 16C, part of the reflection film 215 coated at a sharp tip end portion of each of the protrusion portions 225a is removed by removing the sharp tip end portion of each of the protrusion portions 225a. An open area 226 is formed at the portion of the first light guide portion 225 where the reflection film 215 is removed. The removal of the tip end portion of each of the protrusion portions 225a, such that the protrusion portions 225a are flat, may be performed by a planarization process (e.g., CMP).

Referring to FIG. 16D, the second light guide portion 227 is formed of a transparent material integrally formed with, or optically coupled to, the first light guide portion 225 with the reflection film 215 interposed therebetween. The second light guide portion 227 may be formed by an injection process. The second light guide portion 227 may be formed of the same material used for the first light guide portion 225, or a material having an index of refraction lower than that of the first light guide portion 225.

As described above, according to example embodiments, because the light guide member is formed by a general injection process, the range of selection of a material for the light guide member increases so that the manufacturing costs may be reduced and a functional structure may be easily formed at the side surface of the light guide member. Also, because the light exit portion and the light guide portion are integrally formed, there is no need to use an expensive optical film (e.g., a prism sheet). The light guide plate according to example embodiments is applied to a reflection/transmissive incorporated type display device so that brightness and/or outdoor visibility may be obtained.

The above light guide plates may be used in portable display devices (e.g., personal digital assistants (PDAs), portable multimedia players (PMPs) and digital multimedia broadcasting (DMB) receivers). Likewise, the above methods may be used in a method of manufacturing portable display devices (e.g., personal digital assistants (PDAs), portable multimedia players (PMPs) and digital multimedia broadcasting (DMB) receivers).

The foregoing is illustrative of example embodiments and is not to be construed as limiting thereof. Although a few example embodiments have been described, those skilled in the art will readily appreciate that many modifications are possible in example embodiments without materially departing from the novel teachings and advantages. Accordingly, all such modifications are intended to be included within the scope of this invention as defined in the claims. In the claims, means-plus-function clauses are intended to cover the structures described herein as performing the recited function, and not only structural equivalents but also equivalent structures. Therefore, it is to be understood that the foregoing is illustrative of various example embodiments and is not to be construed as limited to the specific embodiments disclosed, and that modifications to the disclosed embodiments, as well as other embodiments, are intended to be included within the scope of the appended claims.

What is claimed is:

1. A light guide plate, comprising:
a transparent light guide member; and
a reflection member filled in the transparent light guide member, the reflection member reflecting light incident on the transparent light guide member and having a plurality of light exit holes through which light reflected inside the transparent light guide member exits,
wherein the light guide plate has a filled-in type light-emitting structure.

2. The light guide plate of claim 1, wherein the reflection member is formed of a metal or a non-metal having a substantially high reflectance, or by coating the metal or the non-metal having the substantially high reflectance on a material having a substantially low reflectance.

3. The light guide plate of claim 2, wherein the light guide member includes:
a light exit portion filling the plurality of light exit holes; and
a light guide portion on a surface of the reflection member opposite to a light exit surface of the reflection member, the light guide portion being integral with or optically coupled to the light exit portion,
wherein the light exit portion has an index of refraction equal to, or greater, than that of the light guide portion.

4. The light guide plate of claim 1, wherein the reflection member is a reflection film formed by coating a metal or a non-metal having a substantially high reflectance.

5. The light guide plate of claim 4, wherein the light guide member includes:
a first light guide portion on a light exit surface of the reflection member; and
a second light guide portion on a surface of the reflection member opposite to the light exit surface of the reflection member, the second light guide portion being integral with or optically coupled to the first light guide portion,
wherein the first light guide portion has an index of refraction equal to, or higher, than that of the second light guide portion.

6. The light guide plate of claim 1, wherein each of the light exit holes has a first opening on a light exit surface of the reflection member and a second opening on a surface opposite to the light exit surface of the reflection member, the first opening being larger than the second opening.

7. The light guide plate of claim 1, wherein each of the light exit holes has an inclined surface at an acute angle with respect to a light exit surface of the reflection member.

8. The light guide plate of claim 7, wherein each of the light exit holes has a reverse trapezoidal shape in which an opening on the light exit surface is larger than an opening on a surface opposite to the light exit surface.

9. The light guide plate of claim 1, wherein a shape of each of the light exit holes on a light exit surface of the reflection member is a closed loop or a polygon.

10. The light guide plate of claim 1, wherein a light exit surface of the reflection member is one selected from the group consisting of a simple mirror surface, a diffusive mirror surface and a directive reflection surface.

11. The light guide plate of claim 1, wherein the transparent light guide member has an index of refraction equal to, or greater, than that of an environment outside of a light exit surface of the reflection member.

12. The light guide plate of claim 1, wherein an interval between adjacent light exit holes corresponds to a distance from each of the light exit holes to a sidewall of the light guide plate on which light is incident.

13. A display device, comprising:
a light source;
the light guide plate according to claim 1, wherein the light guide plate is configured to guide light emitted from the light source towards a light exit surface of the reflection member;
a reflection plate on a side of the light guide plate opposite to the light exit surface of the reflection member; and
a display panel configured to form an image by modulating light exiting from the light guide plate.

14. The display device of claim 13, wherein the reflection member is formed of a metal or a non-metal having a substantially high reflectance, or by coating the metal or the non-metal having the substantially high reflectance on a material having a substantially low reflectance.

15. The display device of claim 14, wherein the light guide member includes:
alight exit portion filling the plurality of light exit holes; and
a light guide portion on a surface of the reflection member opposite to the light exit surface of the reflection member, the light guide portion being integral with or optically coupled to the light exit portion,
wherein the light exit portion has an index of refraction equal to, or greater, than that of the light guide portion.

16. The display device of claim 13, wherein the reflection member is a reflection film formed by coating a metal or a non-metal having a substantially high reflectance.

17. The display device of claim 16, wherein the light guide member includes:
a first light guide portion on the light exit surface of the reflection member; and
a second light guide portion on a surface of the reflection member opposite to the light exit surface of the reflection member, the second light guide portion being integral with or optically coupled to the first light guide portion,
wherein an index of refraction of the first light guide portion is equal to, or greater, than that of the second light guide portion.

18. The display device of claim 13, wherein each of the light exit holes has a first opening on the light exit surface of the reflection member and a second opening on a surface opposite to the light exit surface of the reflection member, the first opening being larger than the second opening.

19. The display device of claim 13, wherein each of the light exit holes has an inclined surface that is at an acute angle with respect to the light exit surface of the reflection member.

20. The display device of claim 19, wherein each of the light exit holes has a reverse trapezoidal shape in which an opening on the light exit surface is larger than an opening on a surface opposite to the light exit surface.

21. The display device of claim 13, wherein a shape of each of the light exit holes on the light exit surface of the reflection member is a closed loop or a polygon.

22. The display device of claim 13, wherein the light exit surface of the reflection member is one selected from the group consisting of a simple mirror surface, a diffusive mirror surface and a directive reflection surface.

23. The display device of claim 13, wherein the transparent light guide member has an index of refraction equal to, or greater, than that of an environment outside of the light exit surface of the reflection member.

24. The display device of claim 13, wherein an interval between adjacent light exit holes corresponds to a distance from each of the light exit holes to a side surface of the light guide plate on which light is incident.

25. The display device of claim 13, wherein the display panel is one selected from the group consisting of a liquid crystal panel, a polymer dispersed liquid crystal panel, an electrowetting display panel and an electrochromic display panel.

26. The display device of claim 13 being a transflective type display device.

27. A method of fabricating a light guide plate, the method comprising:
providing a reflection plate having a plurality of light exit holes; and
forming a light guide member having the reflection plate therein by providing a transparent material at side surfaces of the reflection plate and inside the plurality of light exit holes.

28. The method of claim 27, wherein the plurality of light exit holes are formed by performing an etching or punching process.

29. The method of claim 27, wherein the light guide member is formed by an injection method.

30. A method of fabricating a light guide plate, the method comprising:
providing a first light guide portion having a plurality of protrusion portions using a first transparent material;
coating a reflection film on a surface of the plurality of protrusion portions of the first light guide portion;
removing a portion of the reflection film coated on an end portion of each of the plurality of protrusion portions of the first light guide portion; and
providing a second light guide portion using a second transparent material, the second light guide portion being integrally formed with or optically coupled to the first light guide portion with the reflection film interposed between the first and second light guide portions.

31. The method of claim 30, wherein removing the portion of the reflection film coated on the end portion of each of the plurality of protrusion portions includes performing at least one process selected from the group consisting of a planarization process, a chemical etching process and a rubbing process.

32. The method of claim 30, wherein providing the first and second light guide portions includes performing an injection method.
